(19) United States
(12) Patent Application Publication
(10) Pub. No.: US 2026/0214052 A1
(43) Pub. Date: Jul. 23, 2026

(54) METHODS AND SYSTEMS FOR ALL-TO-ALL COMMUNICATIONS IN DISTRIBUTED COMPUTING SYSTEMS

(71) Applicant: MangoBoost, Inc., Bellevue, WA (US)

(72) Inventors: Yiran LEI, Bellevue, WA (US); Daniar KURNIAWAN, Bellevue, WA (US); Heetaek JEONG, Bellevue, WA (US); Eriko NURVITADHI, Bellevue, WA (US)

(21) Appl. No.: 19/453,373

(22) Filed: Jan. 20, 2026

Related U.S. Application Data
(60) Provisional application No. 63/748,392, filed on Jan. 22, 2025.

(51) Int. Cl. H04L 47/125; H04L 12/18; H04L 41/16; H04L 67/1001

(52) U.S. Cl. CPC H04L 47/125; H04L 12/1881; H04L 41/16; H04L 67/1001

(57) ABSTRACT

Technologies for scheduling all-to-all communication in a distributed system is disclosed. An example method includes determining two categories of network links that differ in characteristics that affect data transfer among devices, obtaining list of data to be transferred from sender devices to receiver devices, identifying data shuffling operations, data transfer operations, and data reconstruction operations with respect to the two categories of network links, and causing execution of the data shuffling operations, data transfer operations, and data reconstruction operations.

### INTRODUCTION

### All-to-all Communication

Various distributed systems utilize all-to-all communication to transfer data between computing devices, such as CPUs (Central Processing Units), GPUs (Graphics Processing Units), NPUs (Neural Processing Units), or the like. For simplicity without losing generality, “GPU” is used below as example for such a computing device. In the context of distributed computing systems, all-to-all communication refers to a scenario where every GPU in a system needs to exchange data with every other GPU in the system. Typically, this means that during an application's runtime, each GPU both sends data to and receives data from all other GPUs in the system.

FIG. 1 illustrates an example of the connections among 8 GPUs in a system, showing the interactions between them. The physical links between the GPUs can differ. The figure specifically shows the example connections from the perspectives of GPU1 and GPU7, describing how each of these GPUs communicates with all the others.

Similarly, every GPU in the system is connected to all the other GPUs, forming a fully interconnected network (not shown). This setup ensures that during application execution, any GPU can send data to and receive data from any other GPU, facilitating all-to-all communication across the entire system.

### Different Characteristics Between Links in Distributed Computing Systems

There can be various links of different categories of characteristics in distributed systems. For simplicity without losing generality, a GPU computing system is used as an example below.

GPU-based systems can use two categories or types of interconnections for communication: intra-server links and inter-server links. Intra-server links (e.g., NVLink) offer much higher bandwidth and lower latency but are limited to communication within a single server. Inter-server links (e.g., Ethernet or InfiniBand) support distributed systems across multiple servers, but have inferior bandwidth and latency compared to intra-server interconnects. FIG. 2 illustrates a physical example GPU system in accordance with the all-to-all communication of FIG. 1, having both intra-server and inter-server links.

### Intra-Server Links

Intra-server links connect devices within a same physical server. For example, a common interconnect used in this context is PCIe (Peripheral Component Interconnect Express), which is a general-purpose interface adapted by various peripheral devices (e.g., SSDs, NICs, GPUs, or the like). However, high-end GPUs often utilize proprietary interconnects (e.g., NVLink from Nvidia) designed for GPU-to-GPU communication to deliver significantly higher bandwidth and lower latency. Examples of intra-server links include, but are not limited to:
PCIe: PCIe 4.0 supports up to 32 GB/s, while PCIe 5.0 can provide up to 64 GB/s in bandwidth per x16 lane.
NVLink (NVIDIA): In DGX-H100/200 system, NVLink and NVSwitch provide 900 GB/s bandwidth between GPU.
Infinity Fabric (AMD): Infinity Fabric provides up to 896 GB/s bandwidth between GPUs in certain multi-GPU configurations.

### Inter-Server Links

Inter-server links are used to connect GPUs housed in different servers. These links are typically built on Ethernet, which operates using the general TCP/IP protocol. In high-performance computing and GPU domains, InfiniBand is often used as an alternative due to its superior performance and lower latency. Inter-server link bandwidth is typically on par with PCIe bandwidth during the same technological period, meaning it offers lower bandwidth compared to proprietary GPU interconnects like NVLink.

### GPU-GPU Communication Across Servers

Typically, to enable direct communication between GPUs in different servers:
1. Each GPU server can deploy the same number of NICs (Network Interface Cards) and GPUs, dedicating one NIC to each individual GPU.
2. Each NIC can be connected to its dedicated GPU via PCIe and provide an external network interface for accessing remote GPUs, e.g., that reside on other server(s).
3. Advanced techniques like GPUDirect RDMA (Remote Direct Memory Access) allow GPUs to communicate directly with remote GPUs through NICs without requiring CPU intervention. This may significantly reduce communication overhead and improve performance.

### Network Bottlenecks

### Straggler

A straggler in this context typically arises when one server is slower than others in completing its data transfer, delaying the overall process. Stragglers can happen due to hardware variability, network issues, or imbalanced data sizes.

### Incast

Incast typically refers to a scenario where multiple senders simultaneously transfer data to the same receiver, potentially overwhelming its network or buffer capacity.

### Payload Decomposition

Payload decomposition is typically a method for improving data transfer in distributed systems by breaking down complex workloads into smaller, manageable steps. The process aims to address performance bottlenecks such as incast and stragglers.

### DPU/IPU/SmartNIC

Data Processing Unit (DPU) (or SmartNIC, or Infrastructure Processing Unit (IPU)) is a specialized processor designed to handle data-centric tasks, particularly those involving networking, storage, and security. DPUs are becoming increasingly important in high-performance computing (HPC), data centers, and cloud infrastructure due to their ability to offload tasks from CPUs, enabling more efficient system operation.

Depending on the product and system, DPUs can be integrated in many ways into the system. For example:
1. DPUs can replace traditional NICs and offload more tasks from servers or network appliances.
2. DPUs can be integrated into network switches, enabling more intelligent data routing and processing directly within the switch.

### BRIEF DESCRIPTION OF THE SEVERAL VIEWS OF THE DRAWINGS

FIG. 1 illustrates an example of the connections among 8 GPUs in a system.

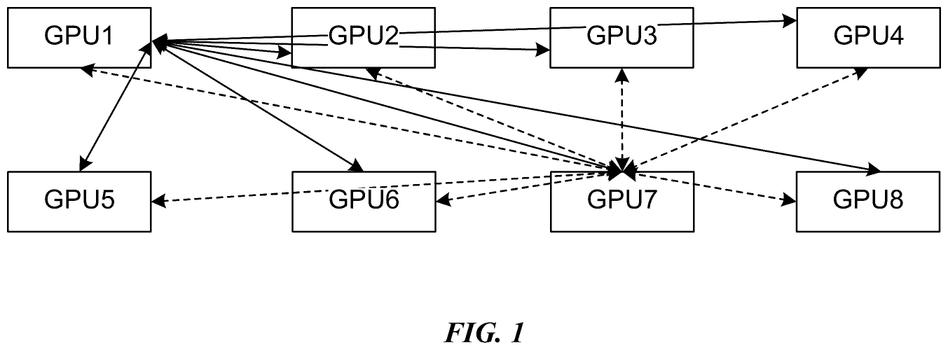

FIG. 2 shows an example view of physical connections between 8 GPUs (4 GPUs per server).

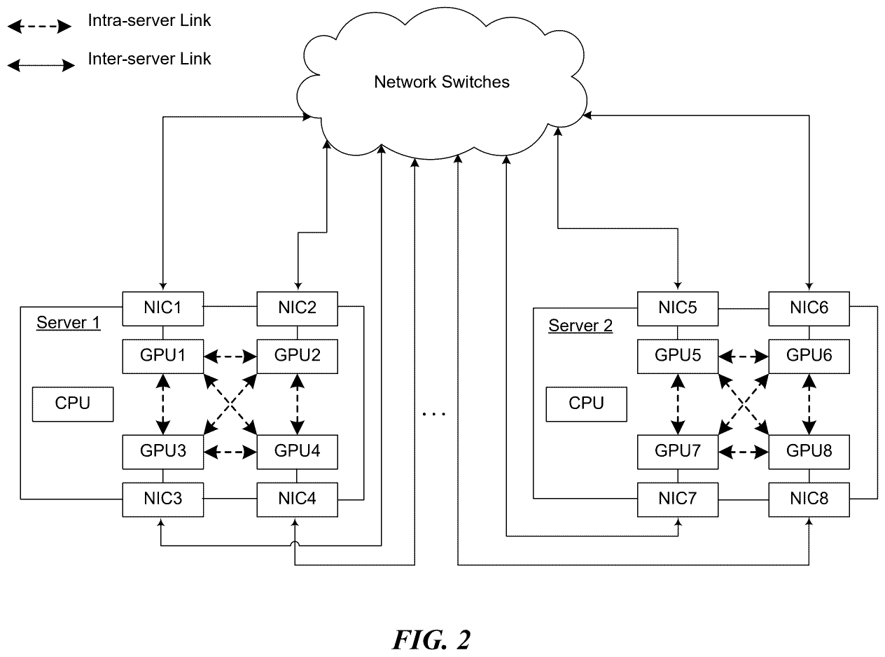

FIG. 3 is a flow diagram illustrating an example overall flow and system to facilitate all-to-all communications in accordance with some embodiments of the presently disclosed technology.

FIG. 4 shows an example comparing the transfer process of Spread-out and FLASH for a server-level transfer in accordance with some embodiments of the presently disclosed technology.

FIG. 5 shows an example decomposition process that converts a demand matrix into a summation of permutation matrices in accordance with some embodiments of the presently disclosed technology.

FIG. 6 shows an example overall flow of feedback between schedulers and monitors in accordance with some embodiments of the presently disclosed technology.

FIG. 7 is a block diagram illustrating a computing system or device used to implement some or all the functionalities of the technology disclosed herein.

### DETAILED DESCRIPTION

### Example Overall System

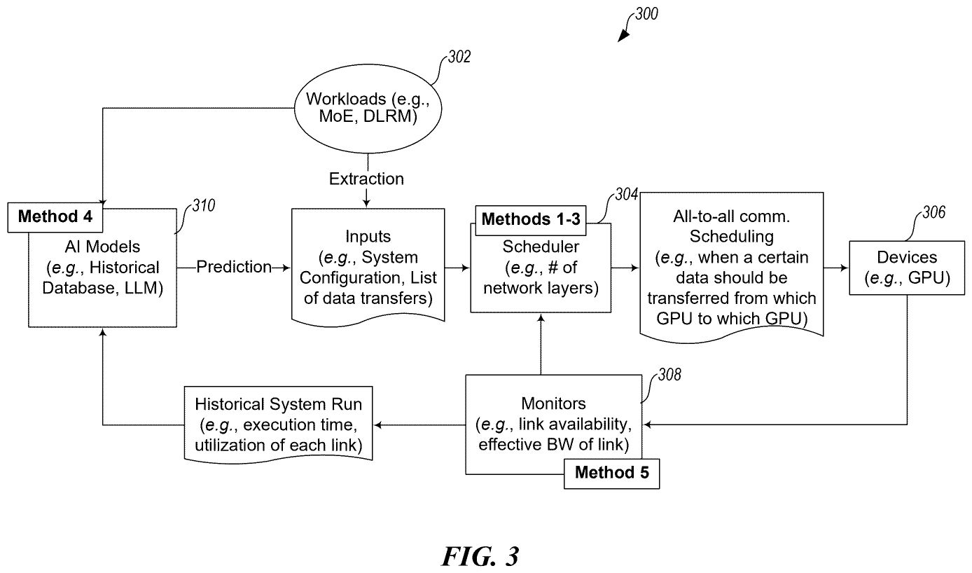

To address at least the network bottleneck issues in the context of all-to-all communication over multiple categories or types of interconnections, systems and methods are developed to facilitate scheduling all-to-all communications among distributed devices. FIG. 3 is a flow diagram illustrating an example overall flow and system 300 to facilitate all-to-all communications in accordance with some embodiments of the presently disclosed technology. As shown in FIG. 3:

Workloads 302: Based on the workload that utilizes all-to-all communication, a list or other indication of data transfers needed (e.g., Data A should be transferred from GPU 1 to GPU 4) is extracted. This can be decided by associated software frameworks (e.g., Deepspeed) or other applicable functional entity. The extracted information is included in Inputs, which can also include system configuration and network information obtained based on the given system and the specification of each component (e.g., bandwidth of inter-server links and intra-server links, number of GPUs, topology of links, or the like.)

Scheduler 304: The scheduler can receive the Inputs, and generate the details of scheduling. For example, if the list of data transfers specifies that GPU1 sends Data A to GPU4, the scheduler can generate that (1) Split Data A to a1 and a2; (2) send a1 from GPU1 to GPU 2 and send a2 from GPU 1 to GPU3 at time t1; (3) send a1 from GPU 2 to GPU 4 and send a2 from GPU 3 to GPU 4 at time t2. Example methods 1-3 are described below on how to generate efficient all-to-all communication scheduling based at least in part on the various network link speeds or other characteristics.

Devices 306: The devices can execute the scheduling in accordance with the details generated from the scheduler.

Monitors 308: Various components in the system 300 (e.g., NIC, network switch, GPU, or the like) can implement applicable monitoring functions to monitor their status and performance. Example method 5 is described below on how the monitored information can be applied to the scheduler for all-to-all communication.

AI (Artificial Intelligence) Models 310: AI models can be used to predict inputs for the scheduler, e.g., for the list of data transfers. Example method 4 is described below on how to use AI models to make such predictions based at least in part on monitored information such as historical information of the past runs of all-to-all communication scheduling.

### Example Method 1

This example method is directed to providing efficient (e.g., with less complexity of scheduling, increased throughput of all-to-all communication, or the like) scheduling for all-to-all communication in a distributed system (e.g., including multiple GPUs) by utilizing speed differences between two homogeneous network link layers or categories in the system (e.g., intra-server link and inter-server link). The method improves the throughput of all-to-all communication as compared with typical scheduling that often overlooks the variability in network link speeds between different locations. This oversight can lead to a skewness in data transfer performance, where some links transfer data faster than others. Consequently, for typical scheduling, bottlenecks arise at slower links to cause inefficiencies in the overall system.

For example, if a fast link (e.g., NVLink) between two GPUs transfers data at 300 GB/s, while a slow link (e.g., Ethernet) operates at 12.5 GB/s, the GPUs relying on the Ethernet link become the bottleneck. All GPUs must pause until the data transfer on the slow link is complete, even though faster links are underutilized during this time.

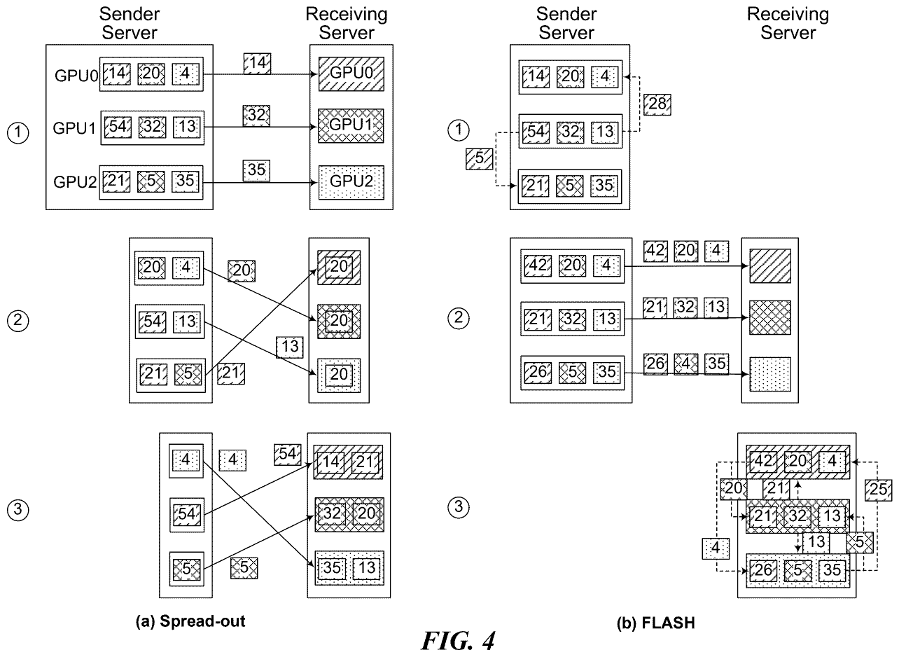

Sub-method 1.1: a deterministic method is used to generate efficient scheduling with lower overhead. Illustratively, the sub-method 1.1 includes:
a. Splitting the data to be transferred into multiple chunks and utilize a high-bandwidth link using multiple paths. FIG. 4 shows an example comparison between (a) Spread-out as a baseline, and (b) FLASH as using this sub-method. As shown, the 3 different shading represent the 3 different GPUs on the receiving server, as well as the data chunks to be transferred to the respective GPUs.
b. A light-weight method can be used to decide how to split the data chunks to multiple paths based on mathematical theorem or other deterministic process (e.g., Birkhoff Theorem)
   i. As an example, a foundation of the decomposition process is the Birkhoff Theorem. The objective of the decomposition process is to transform the all-to-all workload into a series of small straggler- and incast-free steps. Mathematically, it is equivalent to decomposing a demand matrix into the summation of some permutation matrices.
      1. The all-to-all workload can be converted or is otherwise equivalent to a demand matrix that describes the total volumes of data to be transferred for all sender to receiver device pairs.
      2. Assume the data volumes, i.e., the matrix elements, are represented by some non-negative integers, e.g., in terms of kilobytes or bytes.
      3. A transfer step in the decomposition process is equivalent to a Scaled Permutation Matrix that describes the volume of data to be sent in this step.
      4. Definition 1. (Scaled) Permutation Matrix is a square matrix that has exactly one entry of (positive scaling factor ×) 1 in each row and in each column with all other entries being 0.
      5. The Permutation Matrix is incast-free because each column (i.e., representing a receiver) has only one non-zero element whose row represents the only sender. It is also straggler-free because all the non-zero elements have the same value.
      6. Therefore, the all-to-all workload can be completed without incast or straggler by following the Permutation Matrices that sums to the demand matrix.
      7. When the demand matrix is a Scaled Doubly Stochastic Matrix (SDSM), Birkhoff's Theorem form the basis to conduct the decomposition.
      8. Definition 2. (Scaled) Doubly Stochastic Matrix is a square matrix with non-negative real numbers, having each row and each column summing to (positive scaling factor ×) 1.
      9. When the demand matrix is special, i.e., SDSM, Birkhoff's Theorem guarantees the existence of a decomposition.

$$\begin{matrix}THEOREM 1 ( BIRKHOFF ' S THEOREM ) . & \\ If X is a Scaled Doubly Stochastic Matrix in which each row and column sums to K , then there exists {θ}_{1} , {θ}_{2} , … , {θ}_{m} \geq 0 , & \end{matrix}$$

$${\sum }_{i = 1}^{m} {θ}_{i} = K and Permutation Matrices {P}_{1} , {P}_{2} , … , {P}_{m} ,$$

$$such that X = {θ}_{1} {P}_{1} + {θ}_{2} {P}_{2} + … + {θ}_{m} {P}_{m}$$

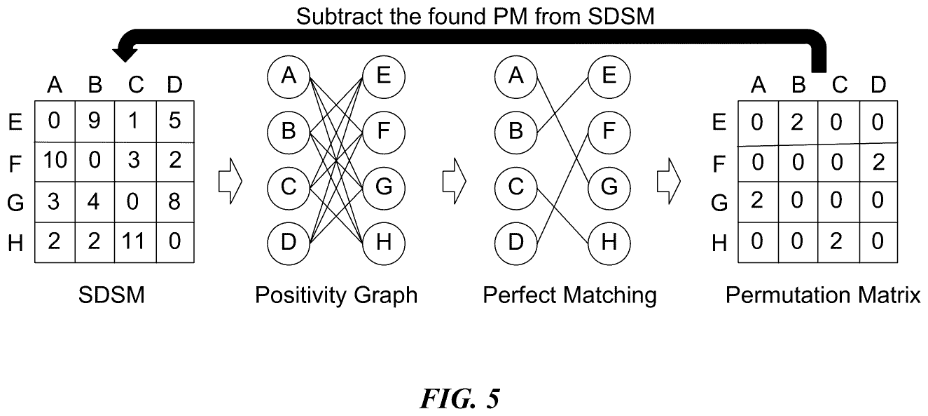

10. The decomposition (i.e., finding θi and Pi) can be computed with the example process shown in FIG. 5, which shows an example decomposition process that converts a demand matrix into a summation of permutation matrices in accordance with some embodiments of the presently disclosed technology.
c. Load balancing: an applicable method, such as the method in (b), can be used to perform intra-server data shuffling (e.g., an intra-server all-to-all operation) in the sender server for balancing the amount of data that will be sent from each sender device (e.g., GPU). An example is illustrated in FIG. 4 as step 1 of (b) FLASH. The sending is straggler-free due to this load balancing.
d. Data transfer: When doing inter-server transfers, each sender device has a unique yet fixed receiver device (thus incast-free) and sends all its data to the receiver, whether the data's destination is the receiver or not. An example is illustrated in FIG. 4 as step 2 of (b) FLASH.
e. Data reconstruction: After inter-server transfers, data is restored to its correct destination by conducting an intra-server all-to-all operation in the receiving server. An example is illustrated in FIG. 4 as step 3 of (b) FLASH.

Sub-method 1.2: using AI models to generate efficient scheduling with improved adaptivity to dynamic workloads. Illustratively, the sub-method 1.2 includes:
a. Instead of the static or deterministic decomposition process (e.g., used in sub-method 1.1), using flexible, adaptive model(s) that learn to decompose a demand matrix into efficient transfer steps based on historical patterns and real-time conditions.
b. Input to the AI model(s) can include system configuration (e.g., topology of the network, number of devices, device model, or the like), specification of two network layers or link categories (e.g., their bandwidth or other characteristics), list of other indication of data transfers between senders and receivers (e.g., demand matrix).
C. Output from the AI model(s) can include the scheduling of data communication between devices. For example, the model(s) can output a sequence of scaled permutation matrices, which specify how data chunks are assigned to different communication paths in each transfer step.

### Example Method 2

This example method to directed to providing efficient scheduling for all-to-all communication in a distributed system by utilizing speed differences between N number of homogeneous network link layers or categories in the system. This example method can be considered a generalized version of example method 1 in terms of the number of network link layers or categories. Similarly, this method improves the throughput of all-to-all communication as compared with typical scheduling that often overlooks the variability in network link speeds between different locations.

Sub-method 2.1: applying the sub-method 1.1 to the N multiple layers or categories iteratively.
a. For example, there are 4 layers or categories (L1, L2, L3, L4) of network links having different network link speeds.
b. In the first iteration, L2, L3, L4 can be combined as Lcomb and sub-method 1.1 can be applied to L1 and Lcomb.
c. In the next iteration, Lcomb can be examined and split into L2 and Lcomb′=(L3, L4), and sub-method 1.1 can be applied to L2 and Lcomb′.
e. In the final iteration, Lcomb′ can be examined and split into L3 and L4, and sub-method 1.1 can be applied to L3 and L4.
f. In this manner, the sub-method 1.1 can iteratively applied to three or more layers or categories of network links.

Sub-method 2.2: using AI models in a manner similar to sub-method 1.2 iteratively toward the N multiple layers or categories.

Data reconstruction can begin at the final layer or category, and propagate back to the first layer or category. Continue using the example above:
a. After all communication for L4 is completed, data chunks are then reconstructed for this layer or category.
b. The reconstructed data from L4 is sent to L3, and data reconstruction on L3 is performed.
c. The reconstructed data from L3 is sent to L2, and data reconstruction on L2 is performed.
d. The reconstructed data from L2 is sent to L1, and data reconstruction on L1 is performed.

### Example Method 3

This example method to is directed to providing efficient scheduling for all-to-all communication in a distributed system by utilizing speed differences between N number of heterogeneous network link layers in the system. This example method can be considered a generalized version of example claim 2 in terms of the heterogeneity (e.g., differences in physical connection, speed, bandwidth, latency, or the like) inside individual network link layer or category. Similarly, this method improves the throughput of all-to-all communication as compared with typical scheduling that often overlooks the variability in network link speeds between different locations.

This example method can be a hybrid method that combines example method 1 and example method 2. One or more holistic AI models can be used to generate efficient scheduling considering both the multiple layers or categories of network links and the heterogeneity inside individual network link layers or categories. Illustratively:
a. Compared to sub-methods 1.2 and 2.2, this method adds the details of network heterogeneity as part of the prediction.
b. Input to the AI model(s) can include system configuration (e.g., topology of the network, number of devices, device model, or the like), specification of all of the heterogeneous network links (e.g., bandwidth or other characteristics), list or other indication of data transfers between senders and receivers (e.g., demand matrix)
c. Output from the AI model(s) can include the scheduling of data communication between devices. For example, the model can output a sequence of scaled permutation matrices, which specify how data chunks are assigned to different communication paths in each transfer step.

### Example Method 4

This example method is directed to generating the expected list or other indication of data transfers based on historical information. The method can remove the synchronization overhead for the execution results among multiple devices in the system. While typical methods may rely on the execution results of the previous run to calculate the next data transfers, this example method can generate expected data transfers without waiting for the previous execution results. The method also has a mechanism to update its decision to improve accuracy and adapt to the changing workload pattern. Two sub-examples of example method 4 are described below:
a. Database sub-method
   i. One or more databases store the data transfers and the corresponding system configuration and workloads.
   ii. When system and workloads are provided, the database(s) are searched to identify the most similar entry to execute.
   iii. After execution, we update the database(s) using the actual data transfers.
b. AI model sub-method
   i. Train the model(s) using system configuration and workloads to predict data transfers between devices (e.g., GPUs).
   ii. When system and workloads are provided, they are fed into the model(s) to generate expected data transfer.
   iii. After execution of the expected data transfer, re-train or fine-tune the model(s) using the latest data transfers.

### Example Method 5

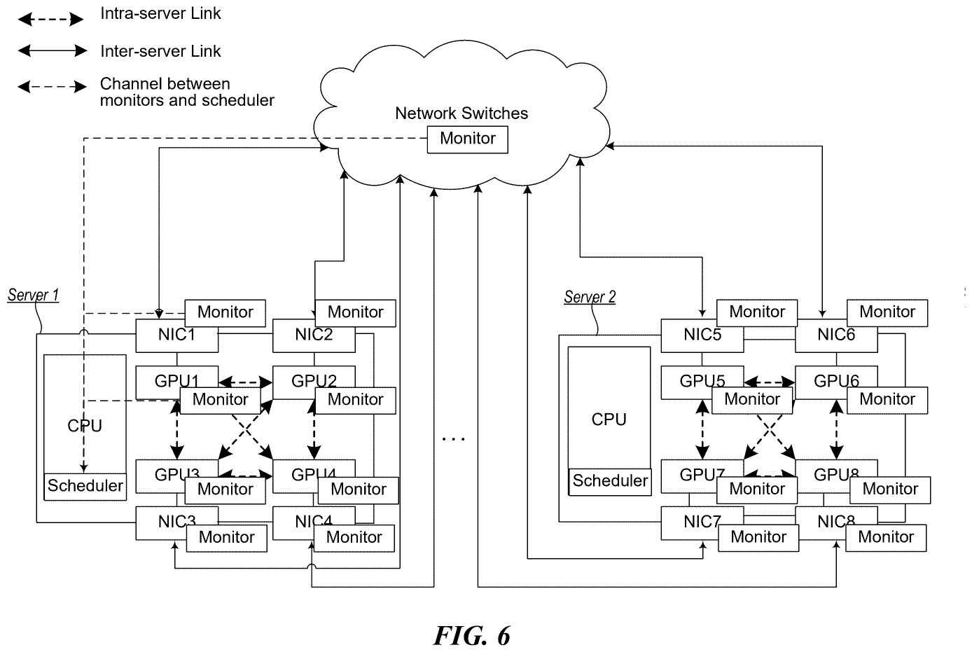

This example method is directed to dynamically collecting the statistical information for network links and dynamically adapting the scheduling. By providing network information to the scheduler, this example method can improve all applicable all-to-all communication scheduling mechanisms. For example, the information provided can be input of example methods 1, 2, and 3. In comparison, typical scheduling methods do not utilize dynamic link information when they schedule all-to-all communication between distributed devices (e.g., GPUs).
1. Depending on the network, this monitoring method can differ. For example,
   a. For intra-server device to device links (e.g., GPU-GPU links), where information can be obtained from the main board of the server or device.
   b. Forinter-server links, the information can be collected in the NIC device and/or network switches.
   c. The information from (a) and/or (b) can be provided to the scheduler which, for example, runs on CPU via their own API.
2. Various devices can provide monitoring functions. For example, DPU can play a role in collecting statistics in 1-a and 1-b above, since it is usually placed in the NIC device and/or network switch.
3. FIG. 6 shows an example of where the monitor(s) can be placed or otherwise implemented in a distributed system including two servers each housing 4 GPUs, as well as the overall flow of feedback between the scheduler and the monitor(s). For simplicity without losing generality, only part of the channel between the monitors and scheduler is illustrated.
4. The scheduler can use the statistical information from monitors in accordance with example methods 1, 2, and 3. If the characteristics (e.g., bandwidth) of some links are different from the specification or provided system configuration, the input of the scheduler can be updated accordingly.
   a. For example, if some network links are broken, the network topology can be updated for the input.
   b. With respect to example methods 1 and 2:
      i. Illustratively, the link bandwidth (or other applicable characteristics) can be averaged for each layer or category, if the characteristics of some links in the layer or category are different from each other or from the specification.
   c. With respect to example method 3:
      i. Since example method 3 allows for heterogeneous links inside a layer or category, the bandwidth (or other characteristics) of each particular link can be updated, e.g., if it is from the specification.

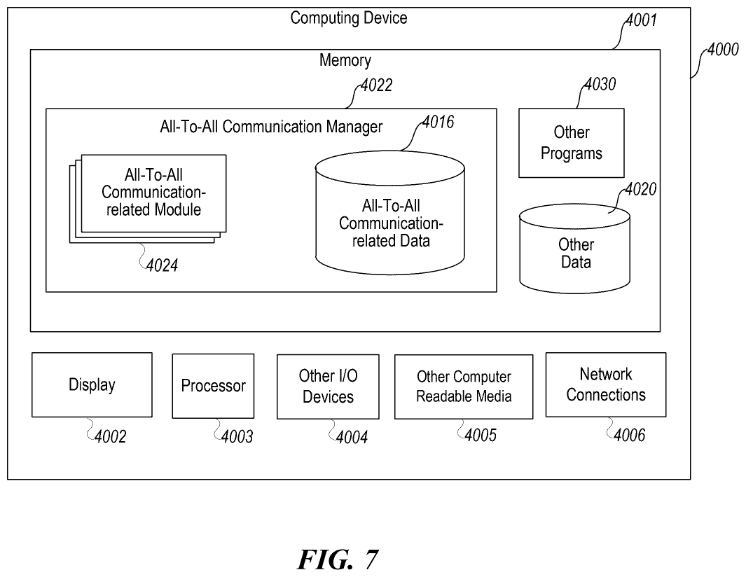

FIG. 7 is a block diagram illustrating a computing system or device 4000 used to implement some or all the functionalities of the technology disclosed herein. The computing system or device 4000 may include the system 300, may be a part of the system 300, or may be separate from the system 300, depending on embodiments of functionalities as performed. According to some embodiments, one or more general purpose or special purpose computing systems or devices may be used to implement the computing system or device 4000. In addition, according to some embodiments, the computing system or device 4000 may comprise one or more distinct computing systems or devices and may span distributed locations. Furthermore, each block shown in FIG. 7 may represent one or more such blocks as appropriate to a specific embodiment or may be combined with other blocks. Also, the all-to-all communication manager 4022 may be implemented in software, hardware, firmware, or in some combination to achieve the capabilities described herein.

As shown, the computing system or device 4000 includes a non-transitory computer memory (“memory”) 4001, a display 4002 (including, but not limited to a light emitting diode (LED) panel, cathode ray tube (CRT) display, liquid crystal display (LCD), touch screen display, projector, etc.), one or more processors 4003 (including, but not limited to one or more of CPUs, GPUs, TPUs, NNPs, FPGAs, or ASICs), Input/Output (“I/O”) devices 4004 (e.g., keyboard, mouse, RF or infrared receiver, universal serial bus (USB) ports, High-Definition Multimedia Interface (HDMI) ports, other communication ports, and the like), other computer-readable media 4005, and network connections 4006. The all-to-all communication manager 4022 is shown residing in memory 4001. In other embodiments, some portion of the contents and some, or all, of the components of the all-to-all communication manager 4022 may be stored on or transmitted over the other computer-readable media 4005. The components of the computing system or device 4000 and all-to-all communication manager 4022 can execute on one or more processors 4003 and implement applicable functions described herein. In some embodiments, the all-to-all communication manager 4022 may operate as, be part of, or work in conjunction or cooperation with other software applications stored in memory 4001 or on various other computing devices. In some embodiments, the all-to-all communication manager 4022 also facilitates communication with peripheral devices via the I/O devices 4004, or with another device or system via the network connections 4006.

The one or more all-to-all communication-related modules 4024 are configured to perform actions related, directly or indirectly, to resource allocation, request scheduling, or other functionalities disclosed herein. In some embodiments, the all-to-all communication-related module(s) 4024 stores, retrieves, or otherwise accesses at least some all-to-all communication-related data on some portion of the all-to-all communication-related data storage 4016 or other data storage internal or external to the computing system or device 4000.

Other code or programs 4030 (e.g., further data processing modules, a program guide manager module, a Web server, and the like), and potentially other data repositories, such as data repository 4020 for storing other data, may also reside in the memory 4001, and can execute on one or more processors 4003. Of note, one or more of the components in FIG. 13 may or may not be present in any specific embodiment. For example, some embodiments may not provide other computer-readable media 4005 or a display 4002.

According to some embodiments, the computing system or device 4000 and all-to-all communication manager 4022 include API(s) that provides programmatic access to add, remove, or change one or more functions of the computing system or device 4000. In some embodiments, components/modules of the computing system or device 4000 and all-to-all communication manager 4022 are implemented using standard programming techniques. For example, the all-to-all communication manager 4022 may be implemented as an executable running on the processor(s) 4003, along with one or more static or dynamic libraries. In other embodiments, the computing system or device 4000 and all-to-all communication manager 4022 may be implemented as instructions processed by a virtual machine that executes as one of the other programs 4030. In general, a range of programming languages known in the art may be employed for implementing such example embodiments, including representative embodiments of various programming language paradigms, including but not limited to, object-oriented (e.g., Java, C++, C#, Visual Basic. NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware embodiment, instructions stored in a memory configure, when executed, one or more processors of the computing system or device 4000 to perform the functions of the all-to-all communication manager 4022. In some embodiments, instructions cause the processor(s) 4003 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by an all-to-all communication manager 4022 embodiment. Also, other functions could be implemented or performed by each component/module, and in different orders, and by different components/modules, yet still achieve the functions of the computing system or device 4000 and all-to-all communication manager 4022.

In addition, programming interfaces to the data stored as part of the computing system or device 4000 and all-to-all communication manager 4022, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The all-to-all communication-related data storage 4016 and data repository 4020 may be implemented as one or more database systems, file systems, or any other technique for storing such information, or any combination of the above, including embodiments using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the all-to-all communication manager 4022.

Furthermore, according to some embodiments, some or all of the components of the computing system or device 4000 and all-to-all communication manager 4022 may be implemented or provided in other manners, such as at least partially in firmware or hardware, including, but not limited to one or more application-specific integrated circuits (“ASICs”), standard integrated circuits, controllers (e.g., by executing appropriate instructions, and including microcontrollers or embedded controllers), field-programmable gate arrays (“FPGAs”), complex programmable logic devices (“CPLDs”), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

The following is a summarization of the claims as originally filed.

In some embodiments, a computer-implemented method for scheduling all-to-all communication in a distributed system includes: receiving information indicating two categories of network links that connect devices to one another in the distributed system, wherein a first category and a second category of the two categories differ in at least one characteristic affecting data transfer; obtaining an indication of data to be transferred from a plurality of sender devices to a plurality of receiver devices in the distributed system; identifying data shuffling operations for devices connected via the first category of network links to load-balance data that will be sent from each of the sender devices; identifying data transfer operations for devices connected via the second category of network links to send data from each sender device to a distinct, single receiver device of the receiver devices; identifying data reconstruction operations for devices connected via the first category of network links to restore data to each of the receiver devices in accordance with the indication; and causing execution of the data shuffling operations, data transfer operations, and data reconstruction operations.

In some embodiments, the plurality of sender devices and the plurality of receiver devices include one or more of Central Processing Units, Graphics Processing Units, or Neural Processing Units.

In some embodiments, the at least one characteristic affecting data transfer includes bandwidth or latency.

In some embodiments, the first category of network links connects devices within a same server.

In some embodiments, the second category of network links connects devices between different servers.

In some embodiments, the second category of network links includes two sub-categories of network links that differ in at least one characteristic affecting data transfer. In some embodiments, the method includes: identifying additional data shuffling operations, data transfer operations, and data reconstruction operations with respect to the two sub-categories of network links; and causing execution of the additional data shuffling operations, data transfer operations, and data reconstruction operations.

In some embodiments, identifying the data shuffling operations, data transfer operations, and data reconstruction operations is performed via a deterministic method.

In some embodiments, identifying the data shuffling operations, data transfer operations, and data reconstruction operations is performed based on one or more trained Artificial Intelligence (AI) models.

In some embodiments, the method includes: obtaining statistical data associated with the execution of the data shuffling operations, data transfer operations, and data reconstruction operations; and re-training or fine-tuning the one or more AI models based at least partly on the statistical data.

In some embodiments, a system includes one or more processors and one or more non-transitory computer-readable media collectively storing instructions that, when collectively executed by the one or more processors, cause the system to perform actions. The actions include: receiving information indicating two categories of network links that connect devices to one another, wherein a first category and a second category of the two categories differ in at least one characteristic affecting data transfer; obtaining an indication of data to be transferred from a plurality of sender devices to a plurality of receiver devices; identifying data shuffling operations for devices connected via the first category of network links to load-balance data that will be sent from each of the sender devices; identifying data transfer operations for devices connected via the second category of network links to send data from each sender device to a distinct, single receiver device of the receiver devices; identifying data reconstruction operations for devices connected via the first category of network links to restore data to each of the receiver devices in accordance with the indication; and causing execution of the data shuffling operations, data transfer operations, and data reconstruction operations.

In some embodiments, the at least one characteristic affecting data transfer includes bandwidth or latency.

In some embodiments, the first category of network links connects devices within a same server and wherein the second category of network links connects devices between different servers.

In some embodiments, the second category of network links includes two sub-categories of network links that differ in at least one characteristic affecting data transfer and the actions include: identifying additional data shuffling operations, data transfer operations, and data reconstruction operations with respect to the two sub-categories of network links; and causing execution of the additional data shuffling operations, data transfer operations, and data reconstruction operations.

In some embodiments, identifying the data shuffling operations, data transfer operations, and data reconstruction operations is performed based on one or more trained Artificial Intelligence (AI) models and the actions include: obtaining statistical data associated with the execution of the data shuffling operations, data transfer operations, and data reconstruction operations; and re-training or fine-tuning the one or more AI models based at least partly on the statistical data.

In some embodiments, a non-transitory processor-readable storage medium stores computer instructions that, when executed by one or more processors, cause actions to be performed. The actions include: receiving information indicating two categories of network links that connect devices to one another, wherein a first category and a second category of the two categories differ in at least one characteristic affecting data transfer; obtaining an indication of data to be transferred from a plurality of sender devices to a plurality of receiver devices; identifying data shuffling operations for devices connected via the first category of network links to load-balance data that will be sent from each of the sender devices; identifying data transfer operations for devices connected via the second category of network links to send data from each sender device to a distinct, single receiver device of the receiver devices; identifying data reconstruction operations for devices connected via the first category of network links to restore data to each of the receiver devices in accordance with the indication; and causing execution of the data shuffling operations, data transfer operations, and data reconstruction operations.

In some embodiments, the at least one characteristic affecting data transfer includes bandwidth or latency.

In some embodiments, the first category of network links connects devices within a same server and wherein the second category of network links connects devices between different servers.

In some embodiments, the second category of network links includes two sub-categories of network links that differ in at least one characteristic affecting data transfer and the actions include: identifying additional data shuffling operations, data transfer operations, and data reconstruction operations with respect to the two sub-categories of network links; and causing execution of the additional data shuffling operations, data transfer operations, and data reconstruction operations.

In some embodiments, identifying the data shuffling operations, data transfer operations, and data reconstruction operations is performed based on one or more trained Artificial Intelligence (AI) models and the actions include: obtaining statistical data associated with the execution of the data shuffling operations, data transfer operations, and data reconstruction operations; and re-training or fine-tuning the one or more AI models based at least partly on the statistical data.

The preceding description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method for scheduling all-to-all communication in a distributed system, comprising:
receiving information indicating two categories of network links that connect devices to one another in the distributed system, wherein a first category and a second category of the two categories differ in at least one characteristic affecting data transfer;
obtaining an indication of data to be transferred from a plurality of sender devices to a plurality of receiver devices in the distributed system;
identifying data shuffling operations for devices connected via the first category of network links to load-balance data that will be sent from each of the sender devices;
identifying data transfer operations for devices connected via the second category of network links to send data from each sender device to a distinct, single receiver device of the receiver devices;
identifying data reconstruction operations for devices connected via the first category of network links to restore data to each of the receiver devices in accordance with the indication; and
causing execution of the data shuffling operations, data transfer operations, and data reconstruction operations.

2. The method of claim 1, wherein the plurality of sender devices and the plurality of receiver devices include one or more of Central Processing Units, Graphics Processing Units, or Neural Processing Units.

3. The method of claim 1, wherein the at least one characteristic affecting data transfer includes bandwidth or latency.

4. The method of claim 1, wherein the first category of network links connects devices within a same server.

5. The method of claim 1, wherein the second category of network links connects devices between different servers.

6. The method of claim 1, wherein the second category of network links includes two sub-categories of network links that differ in at least one characteristic affecting data transfer.

7. The method of claim 6, comprising:
identifying additional data shuffling operations, data transfer operations, and data reconstruction operations with respect to the two sub-categories of network links; and
causing execution of the additional data shuffling operations, data transfer operations, and data reconstruction operations.

8. The method of claim 1, wherein identifying the data shuffling operations, data transfer operations, and data reconstruction operations is performed via a deterministic method.

9. The method of claim 1, wherein identifying the data shuffling operations, data transfer operations, and data reconstruction operations is performed based on one or more trained Artificial Intelligence (AI) models.

10. The method of claim 1, comprising:
obtaining statistical data associated with the execution of the data shuffling operations, data transfer operations, and data reconstruction operations; and
re-training or fine-tuning the one or more AI models based at least partly on the statistical data.

11. A system comprising:
one or more processors; and
one or more non-transitory computer-readable media collectively storing instructions that, when collectively executed by the one or more processors, cause the system to perform actions, the actions comprising:
receiving information indicating two categories of network links that connect devices to one another, wherein a first category and a second category of the two categories differ in at least one characteristic affecting data transfer;
obtaining an indication of data to be transferred from a plurality of sender devices to a plurality of receiver devices;
identifying data shuffling operations for devices connected via the first category of network links to load-balance data that will be sent from each of the sender devices;
identifying data transfer operations for devices connected via the second category of network links to send data from each sender device to a distinct, single receiver device of the receiver devices;
identifying data reconstruction operations for devices connected via the first category of network links to restore data to each of the receiver devices in accordance with the indication; and
causing execution of the data shuffling operations, data transfer operations, and data reconstruction operations.

12. The system of claim 11, wherein the at least one characteristic affecting data transfer includes bandwidth or latency.

13. The system of claim 11, wherein the first category of network links connects devices within a same server and wherein the second category of network links connects devices between different servers.

14. The system of claim 11, wherein the second category of network links includes two sub-categories of network links that differ in at least one characteristic affecting data transfer and wherein the actions comprise:
identifying additional data shuffling operations, data transfer operations, and data reconstruction operations with respect to the two sub-categories of network links; and
causing execution of the additional data shuffling operations, data transfer operations, and data reconstruction operations.

15. The system of claim 11, wherein identifying the data shuffling operations, data transfer operations, and data reconstruction operations is performed based on one or more trained Artificial Intelligence (AI) models and wherein the actions comprise:
obtaining statistical data associated with the execution of the data shuffling operations, data transfer operations, and data reconstruction operations; and
re-training or fine-tuning the one or more AI models based at least partly on the statistical data.

16. A non-transitory processor-readable storage medium storing computer instructions that, when executed by one or more processors, cause actions to be performed, the actions comprising:
receiving information indicating two categories of network links that connect devices to one another, wherein a first category and a second category of the two categories differ in at least one characteristic affecting data transfer;
obtaining an indication of data to be transferred from a plurality of sender devices to a plurality of receiver devices;
identifying data shuffling operations for devices connected via the first category of network links to load-balance data that will be sent from each of the sender devices;
identifying data transfer operations for devices connected via the second category of network links to send data from each sender device to a distinct, single receiver device of the receiver devices;
identifying data reconstruction operations for devices connected via the first category of network links to restore data to each of the receiver devices in accordance with the indication; and
causing execution of the data shuffling operations, data transfer operations, and data reconstruction operations.

17. The storage medium of claim 16, wherein the at least one characteristic affecting data transfer includes bandwidth or latency.

18. The storage medium of claim 16, wherein the first category of network links connects devices within a same server and wherein the second category of network links connects devices between different servers.

19. The storage medium of claim 16, wherein the second category of network links includes two sub-categories of network links that differ in at least one characteristic affecting data transfer and wherein the actions comprise:
identifying additional data shuffling operations, data transfer operations, and data reconstruction operations with respect to the two sub-categories of network links; and
causing execution of the additional data shuffling operations, data transfer operations, and data reconstruction operations.

20. The storage medium of claim 16, wherein identifying the data shuffling operations, data transfer operations, and data reconstruction operations is performed based on one or more trained Artificial Intelligence (AI) models and wherein the actions comprise:
obtaining statistical data associated with the execution of the data shuffling operations, data transfer operations, and data reconstruction operations; and
re-training or fine-tuning the one or more AI models based at least partly on the statistical data.
